(19) United States
(12) Patent Application Publication
(10) Pub. No.: US 2002/0194974 A1
(43) Pub. Date: Dec. 26, 2002

(54) Circular saw blade for cutting ferrous materials

(76) Inventors: Roman Morris, Hickory, NC (US); Vladimir Karnicki, Baltimore, MD (US)

Correspondence Address: HARNESS, DICKEY & PIERCE, P.L.C., P.O. BOX 828, BLOOMFIELD HILLS, MI, 48303, US

(21) Appl. No.: 09/891,942

(22) Filed: Jun. 26, 2001

(51) Int. Cl. B27B 33/08

(52) U.S. Cl. 83/846; 83/855

(57) ABSTRACT

A saw blade having an annular body constructed of a first material having a perimeter where a plurality of teeth are formed into the perimeter. A plurality of carbide inserts, including a cutting edge, affixed to a respective tooth. The cutting edge includes a peak formed by an angle, a first side of the angle being shorter than a second side of the angle, wherein each adjacent tooth includes the peak being disposed on opposing side of the cutting edge.

### FIELD OF THE INVENTION

The present invention relates generally to circular saw blades, and more particularly to circular saw blades including inserts adapted for cutting ferrous material.

### BACKGROUND

It is known in the art to have saw blades adapted to cut ferrous material such as steel studs. These saw blades may or may not include inserts of a hardened material to increase cutting ability. Generally, saw blades that include inserts have carbide tips that are adapted to tear-away or chop-away small portions of metal at a time. Oftentimes, the prior art circular saw blades will have alternating insert designs where one insert is adapted to remove a larger portion of material than the following or leading insert. In this way, it is believed that a more efficient cut and cleaner cut will be formed within the material.

Generally, these inserts are formed separately and machined or cut before being fit into the saw blade. The machining or forming of the inserts generally includes extensive angles or other shapes being formed into the insert itself. The different forms of the angles and shapes are generally believed to create a greater efficiency in the cutting of a material. However, in creating such numerous indentations and angles in the face or edges of the insert creates additional steps and increased labor in the production of the inserts. Furthermore, an inventory of each individual insert must be kept on hand for saw blade production.

### SUMMARY OF THE INVENTION

The present invention includes a circular saw blade which includes a plurality of teeth situated on the perimeter thereof. Each of the plurality of teeth includes an insert formed of a hardened material, preferably carbide. Each of the inserts includes a leading face which terminates at a cutting edge at the upper radial edge of the insert. The cutting edge is defined by an angled surface which includes a shorter side and a longer side. The inserts are arranged such that adjacent inserts have an alternating pattern such that the shorter side of the angled surface is alternated to different sides of the blade.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a plan view of a circular saw blade including carbide inserts on the teeth according to the principles of the present invention;

FIG. 2 is a detail of an edge of the saw blade of FIG. 1 including the carbide inserts on the teeth;

FIG. 3 is a front detail of a singular insert according to the principles of the present invention;

FIG. 3a is a top plan view of a single insert according to the principles of the present invention;

FIG. 4 is a detail of two consecutive inserts of the saw blade taken in the direction of arrow A from FIG. 2.

### DETAILED DESCRIPTION OF THE PREFERRED EMBODIMENTS

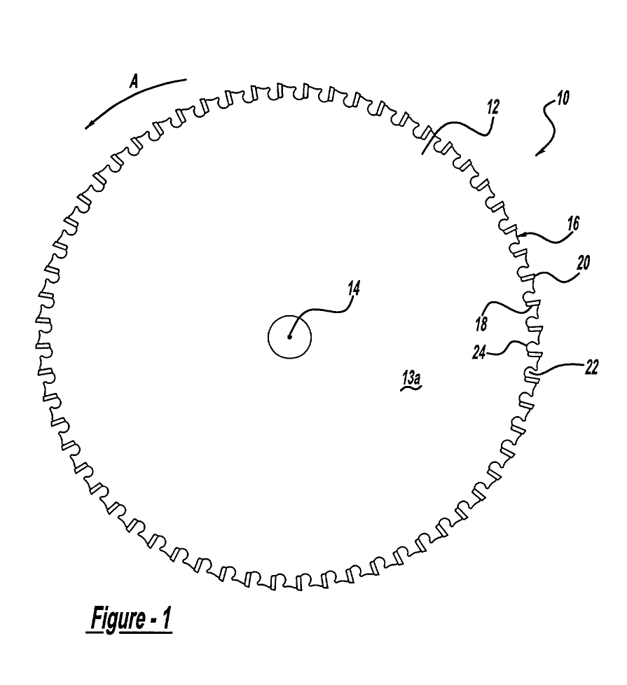

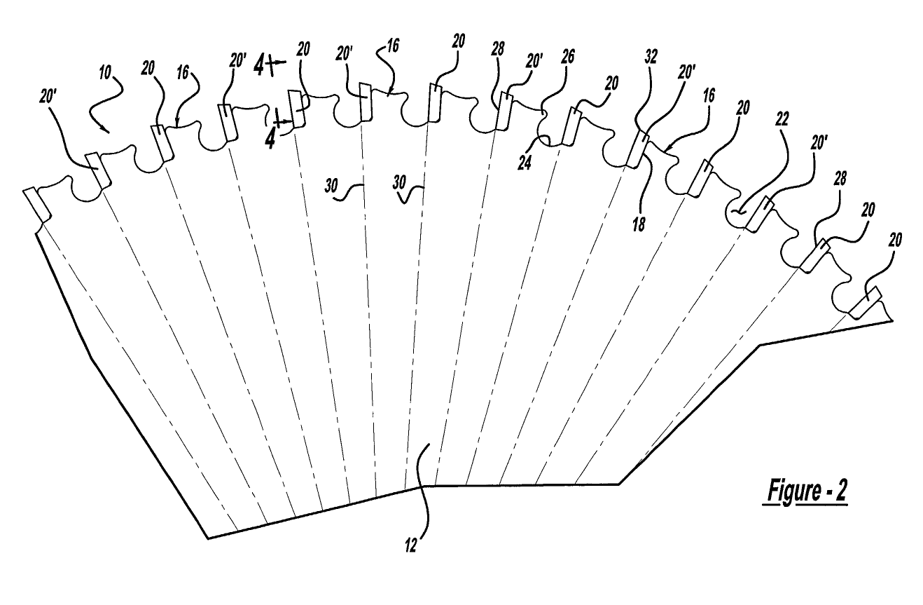

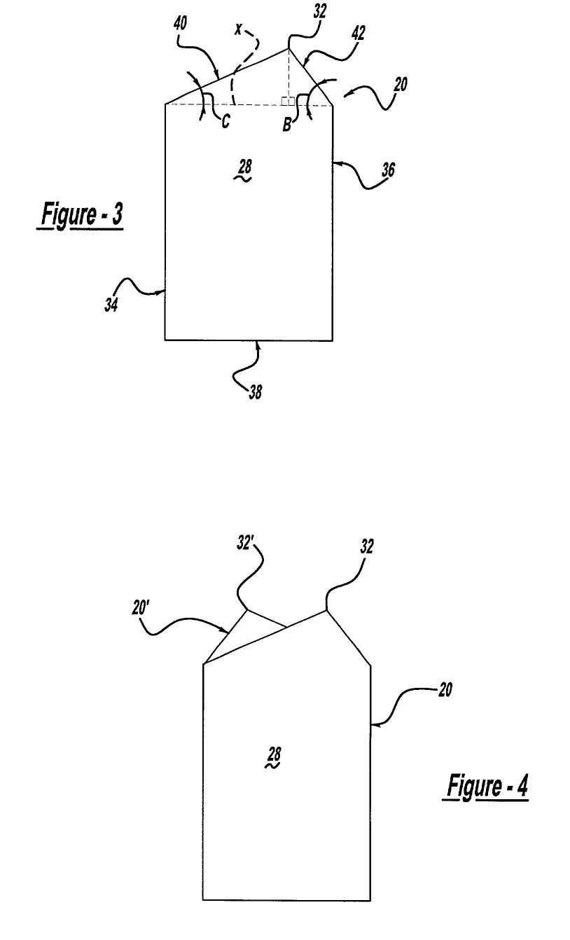

With reference to FIGS. 1 and 2, a circular saw blade 10 is disclosed. The circular saw blade 10 includes a body 12, having two sides 13a and 13b (where only one side is shown here). The saw blade 10 is designed to turn in the direction of arrow A about an axis of rotation 14. Teeth 16 are formed around the perimeter of the body 12. The teeth 16 each include a shoulder 18 each separated by a gullet 22. An insert 20,20′ is affixed to each of the respective shoulders 18. The gullet 22 is an open area that is formed by an arc 24 where a hip 26 of a preceding tooth 16 extends over the arc 24 of the gullet 22. The arc 24 terminates at the leading face 28 of an insert 20. The leading face 28 of the inserts 20,20′ are generally parallel with a radius 30 of the circular saw blade 10. The radius 30 extends from the axis of rotation 14 at the center of the circular saw blade 10. The distal radial edge of the inserts 20,20′ include a peak 32,32′ best shown in FIG. 3, which defines an upper end of the cutting edge of the insert 20.

The inserts 20,20′ are affixed to the tooth 16 through welding, soldering or other suitable means. Thus, the saw blade turns about the axis of rotation 14 in the direction of arrow A so that the leading face 28 of the inserts 20,20′ may engage a material.

With reference to FIGS. 3 and 3a, the detail of a singular insert 20 is shown. The upper cutting edge of the leading face 28 of the insert 20 includes a peak 32. The insert 20 further includes two generally parallel sides 34, 36 and a base 38 generally perpendicular to the sides 34, 36. The peak 32 is an apex of an angle created by two angled surfaces 40, 42 which terminate into respective sides 34, 36. The two angled surfaces 40, 42 are formed by initially top grounding an 8°-10° top bevel, thus forming angled surface 40. A second process grinds a 45° chamfer across approximately one third of the tooth width thus forming angled surface 42. The inserts 20, have a leading face 28 which is a mirror image of the leading face 28 of the inserts 20.

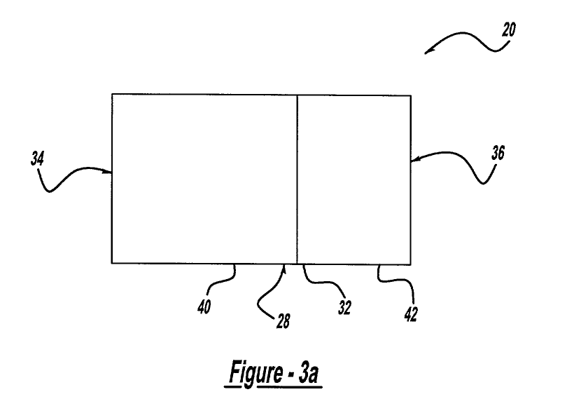

With reference to FIG. 4 taken in the direction of line 4-4 of FIG. 2, the peaks 32,32′ of inserts 20,20′ respectively are shown to alternate along the circumference of the circular saw blade 10. Here the first peak 32 of a first insert 20 is nearer to a first side while the second peak 32, of the second insert 20, is nearer to a second side.

As the circular saw blade 10 rotates about the axis of rotation 14 each alternating peak 32, 32′ takes material from a different side of the channel being cut.

Preferably, the insert 20 is formed of a carbide material including, preferably, 8.6% TiC, 12% TaA(Nb)C, and 9.5% Co. Furthermore, the average preferred grain size of the carbide material would be in the range of 1-1.5 micrometers in diameter.

The angle sides 40,42, forming the cutting edge of the insert 20, include preferable internal angles B,C. These internal angles B,C are defined relative to a parallel “X” of the axis of rotation. Angle B, being associated with the shorter angle side 42 has a range of 40-50 degrees, preferably being about 45 degrees. Angle C, being associated with the longer angle side 40, has a range of 6-10 degrees, and preferably being about 8 degrees.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A circular saw blade, comprising:
an annular body constructed of a first material having a perimeter with a plurality of shoulders formed into said perimeter; and
a plurality of inserts each affixed to a respective one of said shoulders, said inserts formed of a second material and including a cutting edge defined along a leading face, each said cutting edge including a first angled surface between 6 and 10° offset from parallel to an axis of rotation of the annular body and including a second angled surface between 40° and 50° offset from parallel to an axis of rotation of the annular body.

2. The saw blade according to claim 1, wherein said cutting edge of said inserts include a peak which is closer to a side of said annular body wherein peaks of adjacent inserts are closer to alternate sides of the annular body.

3. The saw blade according to claim 1, wherein said inserts are formed from carbide.

4. The saw blade according to claim 1, wherein said carbide inserts include approximately 8.6 percent TiC, 12 percent TaNbc, and 9.5 percent Co.

5. An insert for a saw blade comprising:
a body portion defining a leading face having a cutting edge, a first and second side, and a bottom edge, said cutting edge defined by a first angled surface extending between 96° and 100° from said first side and a second angled surface intersecting said first angled surface and extending between 130° and 140° from said second side.

6. The insert according to claim 5, wherein said body portion is made from carbide.

7. The insert according to claim 6, wherein said body portion includes approximately 8.6 percent TiC, 12 percent TaNbC, and 9.5 percent Co.
